(19) United States
(12) Patent Application Publication
(10) Pub. No.: US 2011/0069606 A1
(43) Pub. Date: Mar. 24, 2011

(54) COMMUNICATION NODE AND METHOD OF PROCESSING COMMUNICATION FAULT THEREOF

(75) Inventors: Jong Dae Park, Daejeon (KR); Ho Yong Ryu, Daejeon (KR); Soon Seok Lee, Daejeon (KR); Byung Seo Kim, Daejeon (KR)

(73) Assignee: Electronics and Telecommunications Research Institute, Daejeon (KR)

(21) Appl. No.: 12/887,785

(22) Filed: Sep. 22, 2010

(30) Foreign Application Priority Data
Sep. 22, 2009 (KR) 10-2009-0089383
Sep. 9, 2010 (KR) 10-2010-0088617

(51) Int. Cl. H04L 12/26

(52) U.S. Cl. 370/216; 370/242

(57) ABSTRACT

A communication node detects a communication fault thereof, and when a communication fault is detected, the communication node determines whether the communication node is included in a transmission path of a data packet with reference to a routing table and transmits the stored communication fault notification message to peripheral communication nodes.

### CROSS-REFERENCE TO RELATED APPLICATION

This application claims priority to and the benefit of Korean Patent Application Nos. 10-2009-0089383 and 10-2010-0088617 filed in the Korean Intellectual Property Office on Sep. 22, 2009 and Sep. 9, 2010, the entire contents of which are incorporated herein by reference.

### BACKGROUND OF THE INVENTION

(a) Field of the Invention

The present invention relates to a communication node and a method of processing a communication fault thereof.

(b) Description of the Related Art

Communication nodes in a transmission path in an ad-hoc network may not perform communication due to various causes. However, a communication node corresponding to an immediately previous hop of a communication node that cannot perform communication cannot know whether a communication node of a next hop to transmit data is in a state that cannot perform communication. Therefore, in an ad-hoc network, even if a communication node of a next hop of a transmission path is in a state that cannot perform communication, the communication node transmits data to a communication node of a next hop, and the communication node repeatedly retransmits data a predetermined number of times until the communication node receives a response to data reception from the communication node of a next hop. Even if the communication node repeatedly retransmits data the predetermined number of times, when the communication node does not receive a response from a communication node of a next hop, the communication node determines that a fault occurs in the communication node of a next hop and resets a transmission path by restoring a routing path.

In this way, in order to know a communication fault of a communication node of a next hop in a transmission path, the communication node should retransmit data several times, and thus the communication node has time loss, and data retransmission may disturb data transmission to another communication node. Thereby, a data reception ratio in a communication node of a final destination is deteriorated, and performance of an entire network is deteriorated.

Further, a communication node in an urgent communication impossibility state should quickly notify of the communication impossibility state to peripheral communication nodes. However, a message or data for notifying a communication state to peripheral communication nodes is formed through a network layer and is transmitted through a physical layer, i.e., is generated and transmitted via several steps of a network, and thus a time period for notifying a communication impossibility state to peripheral communication nodes may be delayed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a communication node and a method of processing a communication fault thereof having advantages of quickly detecting a communication impossibility state and quickly notifying the communication impossibility state to peripheral communication nodes.

An exemplary embodiment of the present invention provides a method of processing a communication fault in a communication node. The method includes: estimating a communication state of the communication node; determining, when the communication fault is detected from the communication state of the communication node, whether it is expected that a data packet is to be transmitted to the communication node; and transmitting, if it is expected that the data packet is to be transmitted to the communication node, a communication fault notification message to peripheral communication nodes.

Another embodiment of the present invention provides a communication node. The communication node includes: a fault detection unit, a transmission unit, and a storage unit. The fault detection unit detects a communication fault of the communication node. The transmission unit transmits a communication fault notification message to peripheral communication nodes. The storage unit stores the communication fault notification message and transfers the communication fault notification message to the transmission unit when the communication fault is detected.

Yet another embodiment of the present invention provides a method of processing a communication fault in a communication node. The method includes: receiving a communication fault notification message from the communication node in which a communication fault occurs; determining whether the communication node in which the communication fault occurs is included in a transmission path of a data packet; and changing, if the communication node in which the communication fault occurs is included in the transmission path of the data packet, the transmission path of the data packet.

### BRIEF DESCRIPTION OF THE DRAWINGS

FIG. 1 is a diagram illustrating a network to which the present invention is applied.

FIGS. 2 and 3 are block diagrams illustrating a configuration of a communication node that is shown in FIG. 1.

FIGS. 4 to 7 are flowcharts illustrating a method of processing a communication fault of a communication node according to first to fourth exemplary embodiments, respectively, of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Now, a communication node and a method of processing a communication fault thereof according to an exemplary embodiment of the present invention will be described in detail with reference to the drawings.

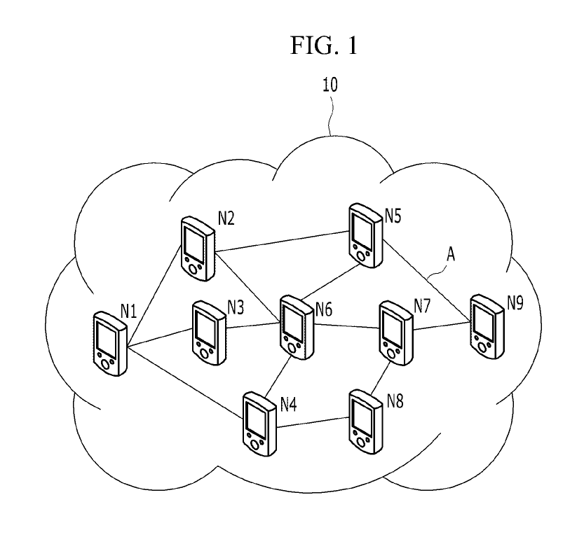

FIG. 1 is a diagram illustrating a network to which the present invention is applied.

FIG. 1 illustrates an ad-hoc network 10, which is a network to which the present invention is applied and in which communication nodes N1-N9 according to an exemplary embodiment of the present invention communicate with a multi-hop.

Referring to FIG. 1, the ad-hoc network 10 includes a plurality of communication nodes N1-N9. Each of the communication nodes N1-N9 may become a source node that generates and transmits a data packet, and may become a destination node to receive a data packet that is transmitted by a source node. Further, the communication nodes N1-N9 exist in a transmission path between a source node and a destination node, and each may become an intermediate node that transmits a data packet that is received from a communication node of an immediate previous hop to a communication node of a next hop.

In FIG. 1, the communication node N1 is a source node, and the communication node N9 is a destination node. In this case, the communication nodes N2-N8 may become intermediate nodes.

The ad-hoc network 10 is a network having no fixed gateway, and all communication nodes N1-N9 can be moved and dynamically connected.

The communication nodes N1-N9 search for a transmission path using a routing protocol, set an optimized transmission path, and transmit a data packet to a communication node of a next hop through the optimized transmission path.

In order to set an optimized transmission path, the communication nodes N1-N9 include a routing table (not shown). A transmission path from a source node to a destination node is stored in the routing table.

The communication nodes N1-N9 set an optimized transmission path by searching for the routing table and transmit a data packet to a communication node of a next hop of the optimized transmission path.

For example, the communication node N1 corresponding to a source node can select a transmission path A that is formed with a shortest hop to a communication node N9 corresponding to a destination node by searching for a routing table. In this case, the communication node N1 can transmit a data packet to a communication node N2 corresponding to a next hop of the transmission path A. Further, when intermediate nodes N2 and N5 existing in the transmission path A determine whether the intermediate nodes N2 and N5 correspond to a destination node, and if the intermediate nodes N2 and N5 do not correspond to a destination node, the intermediate nodes N2 and N5 determine whether a communication node corresponding to a next hop of the transmission path A exists in the routing table and transmit a data packet to a communication node corresponding to a next hop.

The communication node N9 corresponding to a destination node determines whether a destination of the received data packet is the communication node N9, and if the destination of the received data packet is the communication node N9, the communication node N9 no longer transmits data.

In the communication nodes N1-N9, a communication fault may occur due to various factors. The communication nodes N1-N9 according to an exemplary embodiment of the present invention detect a communication fault thereof and transmit a communication fault notification message to peripheral communication nodes. In this case, the communication nodes N1-N9 transmit a communication fault notification message in a broadcasting transmission form to peripheral communication nodes.

Further, after transmitting a communication fault notification message to peripheral communication nodes, the communication nodes N1-N9 can change a state of a transmission path in a routing table.

Further, when the communication nodes N1-N9 receive a communication fault notification message from peripheral communication nodes, the communication nodes N1-N9 change a transmission path state to a destination node in the routing table through path restoration. That is, when the communication nodes N1-N9 receive a communication fault notification message from peripheral communication nodes, in order to not transmit a data packet to the communication node having transmitted the communication fault notification message, the communication nodes N1-N9 change a transmission path state to a destination node.

For example, when the communication node N6 of FIG. 1 detects a communication fault thereof, the communication node N6 transmits a communication fault notification message to peripheral communication nodes N2, N3, N4, N5, and N7.

Further, communication nodes N2, N3, N4, N5, and N7, having received a communication fault notification message from the communication node N6, determine whether a data packet to transmit to a destination node through the communication node N6 exists, and if a data packet to transmit to a destination node through the communication node N6 exists, the communication nodes N2, N3, N4, N5, and N7 change a transmission path state to a destination node in a routing table through path restoration and reset an optimized transmission path.

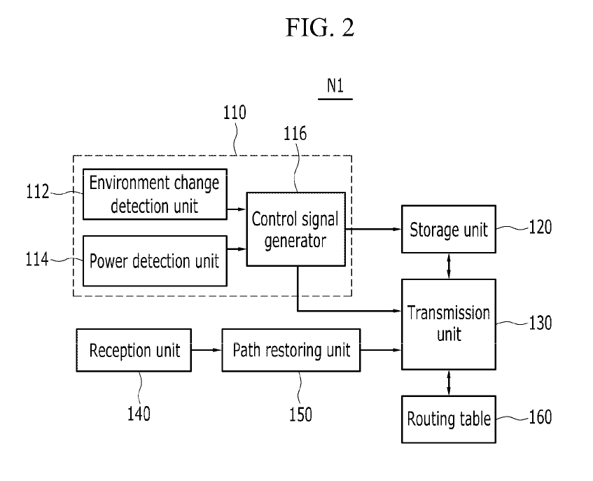

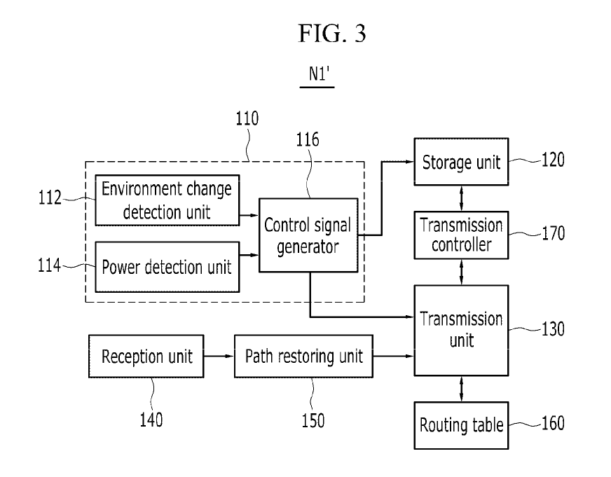

FIGS. 2 and 3 are block diagrams illustrating a configuration of a communication node that is shown in FIG. 1. FIGS. 2 and 3 illustrate only a communication node N1 of communication nodes N1-N9, and communication nodes N2-N9 are formed similar to the communication node N1.

Referring to FIG. 2, the communication node N1 includes a fault detection unit 110, a storage unit 120, a transmission unit 130, a reception unit 140, a path restoring unit 150, and a routing table 160.

The fault detection unit 110 estimates a communication state of the communication node N1 and detects a communication fault from the communication state of the communication node N1. The communication fault indicates a case where communication cannot be performed, a case having a high probability in which communication is to be delayed, or a case having a high probability in which a data packet is to be damaged.

The fault detection unit 110 includes an environment change detection unit 112, a power detection unit 114, and a control signal generator 116.

The environment change detection unit 112 detects internal and external environment changes and detects an abnormal symptom from the internal and external environment changes. Here, the abnormal symptom indicates a case where internal and external environment changes belong to a condition causing a communication fault. For example, the environment change detection unit 112 may detect an abnormal symptom such as abrupt increase of pressure, an abrupt increase of temperature, and crossing or cutting of a circuit while monitoring internal and external pressures and temperatures, and an internal circuit. The environment change detection unit 112 may include at least one sensor (not shown) for detecting internal and external environment changes.

The power detection unit 114 detects power that is supplied to the communication node N1, thereby detecting an abnormal symptom. Here, an abnormal symptom indicates a case where power that is supplied to the communication node N1 belongs to a condition causing a communication fault. For example, the power detection unit 114 may detect an abnormal symptom such as forcible power off and battery insufficiency by detecting power that is supplied to the communication node N1.

When an abnormal symptom occurs from the environment change detection unit 112 and when an abnormal symptom occurs from the power detection unit 114, the control signal generator 116 generates a control signal and transfers the control signal to the storage unit 120 and the transmission unit 130.

A data packet to be generally transmitted is formed through a network layer and a data link layer, and a data packet that is formed through a network layer and a data link layer is transmitted through a physical layer. When a communication fault is detected, if a communication fault notification message is formed through a network layer and a data link layer and is transmitted through a physical layer, a time period that is consumed until transmitting the communication fault notification message to peripheral communication nodes can be extended.

In order to solve such a problem, a communication fault notification message according to an exemplary embodiment of the present invention is previously prepared and stored in the storage unit 120. The storage unit 120 may exist in a physical layer. When the storage unit 120 receives a control signal from the control signal generator 116, the storage unit 120 transfers the stored communication fault notification message to the transmission unit 130.

When the transmission unit 130 receives the communication fault notification message from the storage unit 120, the communication node determines whether the communication node is included in a transmission path of a data packet with reference to the routing table 160, and if the communication node is included in a transmission path of a data packet, the transmission unit 130 transmits the communication fault notification message to peripheral communication nodes.

In this way, when the transmission unit 130 receives a communication fault notification message from the storage unit 120 without necessity to form a communication fault notification message through a network layer and a data link layer, the transmission unit 130 immediately transmits the communication fault notification message to the peripheral communication nodes and thus the transmission unit 130 can quickly transmit the communication fault notification message to the peripheral communication node and the peripheral communication nodes can quickly correspond to a communication fault.

Further, when the communication fault notification message is received from the storage unit 120, the transmission unit 130 determines whether a transmitting data packet exists. In this case, if a transmitting data packet exists, when an abnormal symptom occurs from the environment change detection unit 112 and when an abnormal symptom occurs from the power detection unit 114 and the generated control signal, the transmission unit 130 can differently process a transmitting data packet according to the generated control signal.

Specifically, when an abnormal symptom occurs from the environment change detection unit 112, if the transmission unit 130 receives the generated control signal, the transmission unit 130 stops transmission of a data packet and transmits a communication fault notification message to peripheral communication nodes. Further, when an abnormal symptom occurs from the power detection unit 114, if the transmission unit 130 receives the generated control signal, the transmission unit 130 completes transmission of a data packet and then transmits the communication fault notification message to the peripheral communication nodes.

That is, because the communication node N1 can determine whether communication cannot be performed according to a factor causing a communication fault, a transmitting data packet can be processed in a state where communication cannot be performed.

When a data packet advancing to a destination node is received, the transmission unit 130 determines whether a destination node is the communication node, and if a destination node is not the communication node, the transmission unit 130 sets an optimized transmission path with reference to the routing table 160. Thereafter, the transmission unit 130 transmits a data packet to a communication node of a next hop of a transmission path.

The reception unit 140 receives a data packet and a communication fault notification message.

When a communication fault notification message is received through the reception unit 140, the path restoring unit 150 determines whether a communication node having transmitted a communication fault notification message exists in a transmission path that is defined in the routing table 160 of the communication node, or a data packet to transmit to the communication node exists, and if a communication node having transmitted a communication fault notification message exists in a transmission path that is defined in the routing table 160 of the communication node, or a data packet to transmit to the communication node exists, the path restoring unit 150 performs path restoration and changes a transmission path state to a destination node in the routing table 160. Accordingly, the transmission unit 130 resets an optimized transmission path with reference to the changed routing table 160 and transmits a data packet through the reset transmission path. When a transmission path to change does not exist in the routing table 160, the path restoring unit 150 quickly performs a process of finding a new transmission path.

A transmission path from a source node to a destination node is stored in the routing table 160.

When a communication fault notification message is frequently generated due to an error or another factor of the environment change detection unit 112 and the power detection unit 114, unnecessary transmission occurs in the network, and this increases transmission load of the network and deteriorates transmission quality of a data packet.

Therefore, a communication node N1′ according to a second exemplary embodiment of the present invention further includes a transmission controller 170 between the storage unit 120 and the transmission unit 130.

The number of times of transmission restriction of a communication fault notification message is set to the transmission controller 170, and the transmission controller 170 transfers a communication fault notification message that is transferred from the storage unit 120 to the transmission unit 130, but when the number of times of transmission of a communication fault notification message exceeds the number of times of transmission restriction of a communication fault notification message within a predetermined time period, the transmission controller 170 does not transfer the communication fault notification message to the transmission unit 130. The number of times of transmission restriction is a design parameter and is a value that can be changed by a user.

Unlike a case of FIG. 3, the transmission controller 170 may be formed within the storage unit 120.

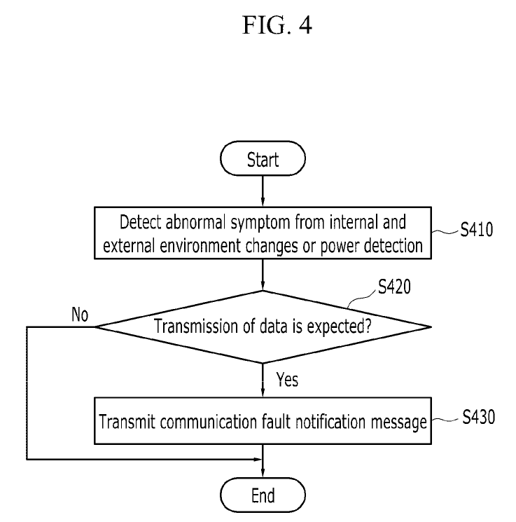

FIG. 4 is a flowchart illustrating a method of processing a communication fault of a communication node according to a first exemplary embodiment of the present invention.

Referring to FIG. 4, when an abnormal symptom is detected by internal and external environment changes or power detection (S410), the communication node N1 determines whether it is expected that data is to be transmitted to the communication node N1 (S420). For example, when the communication node N1 is included in a transmission path or when the communication node N1 is a destination, the communication node N1 may determine that it is expected that data is to be transmitted to the communication node N1. In this case, the communication node N1 determines whether the communication node N1 is an intermediate node or a destination node of a transmission path through the routing table 160 or previous data reception and transmission.

When the communication node N1 is presently included in a transmission path, the communication node N1 transmits a communication fault notification message to peripheral communication nodes (S430).

In this way, when the communication node N1 detects an abnormal symptom thereof, if it is expected that data is to be transmitted to the communication node N1, the communication node N1 quickly transmits a communication fault notification message to peripheral communication nodes and thus the peripheral communication nodes can quickly correspond to a communication fault of the communication node N1.

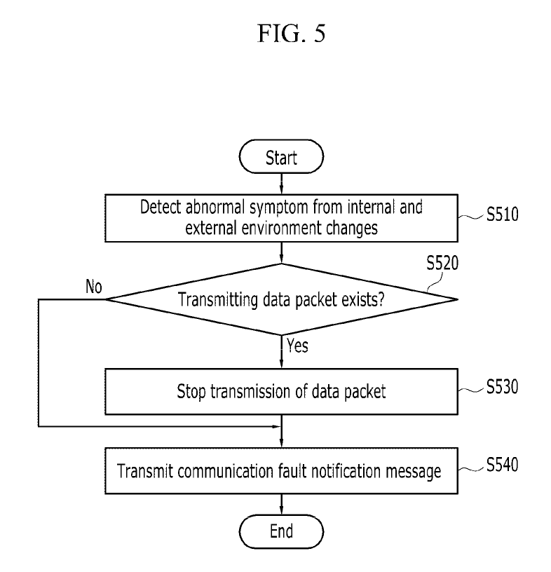

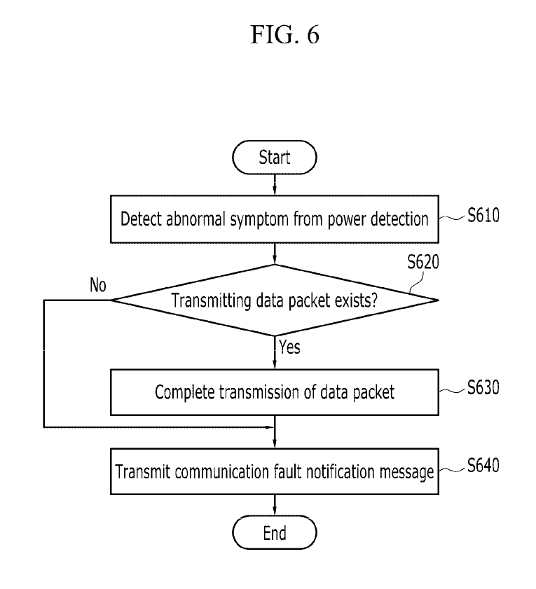

For a situation in which a transmitting data packet exists in the communication node N1 in which an abnormal symptom is detected, operation of the communication node N1 will be described with reference to FIGS. 5 and 6.

FIGS. 5 to 6 are flowcharts illustrating a method of processing a communication fault of a communication node according to second and third exemplary embodiments, respectively, of the present invention.

Referring to FIG. 5, when an abnormal symptom is detected from internal and external environment changes (S510), the communication node N1 determines whether the communication node N1 is presently included in a transmission path and transmits a communication fault notification message to peripheral communication nodes. The communication node N1 determines whether a transmitting data packet exists (S520), and if a transmitting data packet exists, the communication node N1 stops transmission of the data packet (S530) and transmits a communication fault notification message to peripheral communication nodes (S540), and if a transmitting data packet does not exist, the communication node N1 transmits a communication fault notification message to peripheral communication nodes.

Referring to FIG. 6, when an abnormal symptom is detected from supplied power detection (S610), the communication node N1 determines whether the communication node N1 is presently included in a transmission path, and transmits a communication fault notification message to peripheral communication nodes. The communication node N1 determines whether a transmitting data packet exists, and if a transmitting data packet exists, the communication node N1 completes transmission of the data packet (S630) and transmits a communication fault notification message to peripheral communication nodes (S640), and if a transmitting data packet does not exist, the communication node N1 transmits a communication fault notification message to peripheral communication nodes.

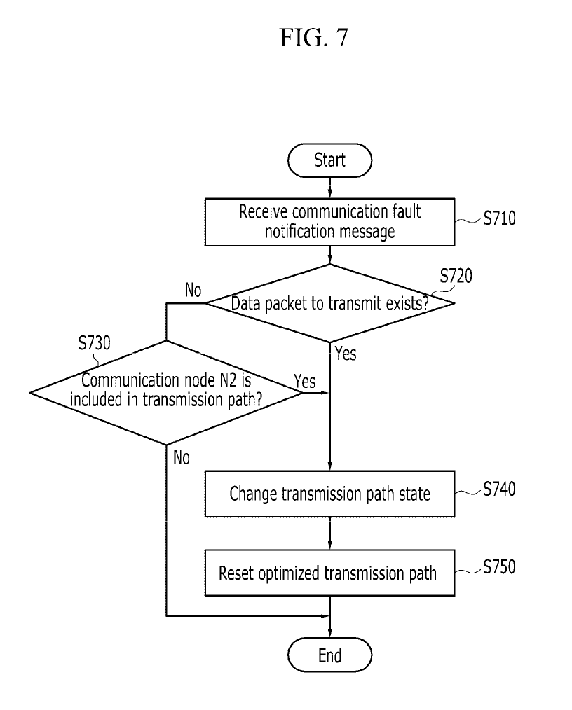

FIG. 7 is a flowchart illustrating a method of processing a communication fault of a communication node according to a fourth exemplary embodiment of the present invention.

Referring to FIG. 7, the communication node N1 receives a communication fault notification message from a peripheral communication node, for example, a communication node N2 (S710).

The communication node N1, having received a communication fault notification message from the communication node N2 determines whether a data packet to transmit to the communication node N2 exists (S720).

If a data packet to transmit to the communication node N2 does not exist, the communication node N1 determines whether the communication node N2 is presently included in a transmission path with reference to a routing table thereof (S730). That is, the communication node N1 determines whether the communication node N2 is a communication node corresponding to a next hop of data transmission.

If the communication node N2 is presently included in a transmission path or if a data packet to transmit to the communication node N2 exists, the communication node N1 changes a transmission path state in the routing table 160 by performing path restoration (S740). Thereafter, an optimized transmission path is reset with reference to the changed routing table (S750). Through such path restoration, the communication node N1 transmits a data packet to a communication node, for example a communication node N3 of a next hop of a transmission path that is optimized by resetting.

In this way, communication nodes N1-N9 according to an exemplary embodiment of the present invention can detect communication faults thereof, and when communication faults thereof are detected, the communication faults can be quickly transmitted to peripheral communication nodes.

Accordingly, the peripheral communication nodes can quickly cope so that a data packet is not transmitted to the communication node in which the communication fault is detected. Thereby, a data reception ratio in a communication node of a final destination can be improved and therefore performance of a network can be improved.

An exemplary embodiment of the present invention may be not only embodied through the above-described apparatus and/or method but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of processing a communication fault in a communication node, the method comprising:
estimating a communication state of the communication node;
determining, when the communication fault is detected from the communication state of the communication node, whether it is expected that a data packet is to be transmitted to the communication node; and
transmitting, if it is expected that the data packet is to be transmitted to the communication node, a communication fault notification message to peripheral communication nodes.

2. The method of claim 1, wherein the estimating of the communication state comprises estimating the communication state from a change of supplied power.

3. The method of claim 2, wherein the transmitting of the communication fault notification message comprises:
determining whether transmitting data packet exists;
completing, if transmitting data packet exists, when the communication fault is detected from the change of the supplied power, data packet transmission; and
transmitting the communication fault notification message.

4. The method of claim 2, wherein the change of the supplied power comprises at least one of forcible power off and battery insufficiency.

5. The method of claim 1, wherein the estimating of the communication state comprises estimating the communication state from internal and external environment changes.

6. The method of claim 5, wherein the transmitting of the communication fault notification message comprises:
determining whether transmitting data packet exists; and
stopping, if transmitting data packet exists, when the communication fault is detected from internal and external environment changes, data packet transmission and transmitting the communication fault notification message.

7. The method of claim 5, wherein the internal and external environment changes comprise at least one of a pressure change, a temperature change, and a circuit change.

8. The method of claim 1, wherein the communication fault notification message is previously prepared and stored in a physical layer.

9. The method of claim 1, wherein the determining of whether it is expected that the data packet is to be transmitted comprises determining whether the communication node exists in a transmission path of the data packet with reference to a routing table.

10. The method of claim 1, wherein the transmitting of the communication fault notification message comprises restricting, when the number of times of transmission of the communication fault notification message exceeds a predetermined restriction number of times, transmission of the communication fault notification message.

11. A communication node comprising:
a fault detection unit that detects a communication fault of the communication node;
a transmission unit that transmits a communication fault notification message to peripheral communication nodes; and
a storage unit that stores the communication fault notification message and that transfers the communication fault notification message to the transmission unit when the communication fault is detected.

12. The communication node of claim 11, further comprising a transmission controller that transfers the communication fault notification message from the storage unit to the transmission unit and that interrupts transfer of the communication fault notification message to the transmission unit when the communication fault notification message that is transferred to the transmission unit exceeds the number of times of transmission restriction.

13. The communication node of claim 11, further comprising a routing table that stores a transmission path of a data packet from a source node to a destination node,
wherein the transmission unit transmits the communication fault notification message to the peripheral communication nodes when it is expected that the data packet is to be transmitted to the communication node with reference to the routing table.

14. The communication node of claim 11, wherein the storage unit is comprised in a physical layer.

15. The communication node of claim 11, wherein the fault detection unit comprises:
an environment change detection unit that detects internal and external environment changes and that detects the communication fault from the internal and external environment changes; and
a power detection unit that detects a change of supplied power and that detects the communication fault from the change of supplied power.

16. The communication node of claim 15, wherein the transmission unit stops transmission of a transmitting data packet and transmits the communication fault notification message, when the communication fault is detected from the internal and external environment changes.

17. The communication node of claim 15, wherein the transmission unit completes transmission of a transmitting data packet and transmits the communication fault notification message, when the communication fault is detected from the change of supplied power.

18. The communication node of claim 11, further comprising:
a reception unit that receives a communication fault notification message from other peripheral communication nodes; and
a path restoring unit that changes, when the other peripheral communication nodes exist in a transmission path of the data packet or when a data packet to transmit to the other peripheral communication nodes exists, a state of the transmission path.

19. A method of processing a communication fault in a communication node, the method comprising:
receiving a communication fault notification message from a communication node in which the communication fault occurs;
determining whether the communication node in which the communication fault occurs is included in a transmission path of a data packet; and
changing, if the communication node in which the communication fault occurs is included in the transmission path of the data packet, the transmission path of the data packet.

20. The method of claim 19, wherein the communication fault notification message is stored in a physical layer of the communication node.
